(19) United States
(12) Patent Application Publication
(10) Pub. No.: US 2015/0224601 A1
(43) Pub. Date: Aug. 13, 2015

(54) Method for the recuperation of unused optical radiation energy of an optical machining apparatus, recuperation apparatus and optical machining apparatus

(71) Applicant: LIMO PATENTVERWALTUNG GMBH & CO. KG, DORTMUND (DE)

(72) Inventor: Thomas Mitra, Dortmund (DE)

(21) Appl. No.: 14/418,783

(22) PCT Filed: Jul. 9, 2013
(86) PCT No.: PCT/EP2013/064473

§ 371 Date: Jan. 30, 2015

(30) Foreign Application Priority Data
Jul. 30, 2012 (DE) 10 2012 106 937.9

(51) Int. Cl. B23K 26/30

(52) U.S. Cl. CPC B23K 26/422

(57) ABSTRACT

A method recuperates unused optical radiation energy of an optical machining apparatus having at least one light source, in particular a laser light source or a light source having a number of LEDs. The method includes operating the at least one light source and generating electromagnetic radiation, subjecting at least one workpiece to the electromagnetic radiation in order to machine the workpiece, and capturing at least a part of the electromagnetic radiation not used for machining the at least one workpiece in a beam trap device of at least one recuperation apparatus. At least a part of the radiation energy of the electromagnetic radiation captured by the beam trap device of the at least one recuperation apparatus is converted into electrical energy. A recuperation apparatus also recuperates unused electromagnetic radiation energy of an optical machining apparatus as does an optical machining apparatus.

The present invention relates to a method for recuperating unused optical radiation energy from an optical machining apparatus, a recuperation apparatus and an optical machining apparatus.

The technical importance of optical machining apparatuses, in particular laser machining apparatuses, by means of which different types of substances can be machined by the application of electromagnetic radiation (in particular laser light) has increased significantly in recent years. Previously, industrial laser machining apparatuses relatively seldom used laser light sources with significantly more than 10 kW optical radiation power. In the meantime, novel machining apparatuses require laser light sources with significantly more power. In this context, laser machining apparatuses for thermal machining of metals, for adapting material properties in functional layers or for complementing conventional ovens in the production of solar cells are to be mentioned in an exemplary manner.

Here, in particular, use is made of diode lasers as laser light sources with a multiplicity of individual emitters which, in conjunction with optical means, are embodied in such a way that they can generate a line-shaped intensity distribution in a work region where laser light is applied onto the workpiece.

All laser machining apparatuses have the problem that only a comparatively small part of the optical (electromagnetic) radiation energy provided by the laser light source is in fact used for machining the workpiece, and so the energy balance of the laser machining apparatuses known from the prior art is relatively inexpedient. Particularly the aforementioned industrial applications of laser machining apparatuses are typical examples where it is technically not possible (and sometimes not even expedient) to use a majority of the optical radiation energy provided for machining the workpiece. Metallic substances reflect a majority of the laser light radiated thereon. Glasses and the materials used for the production of solar cells by contrast transmit and reflect a majority of the laser light radiated thereon. Tests have shown that only between 10% and 20% of the irradiated laser light is in fact used for the laser machining process in laser machining methods and apparatuses known from the prior art. In some machining methods, even more than 90% of the irradiated laser light remains unused in the laser machining process.

Currently, the portion of the laser light that cannot be used for the laser machining process is captured by so-called beam traps in the prior art. These beam traps are typically embodied in such a way that they are able to capture, in a targeted manner, laser light which is transmitted through the workpiece to be machined or reflected by the workpiece to be machined. Such beam traps are embodied in such a way that the laser light can reach a cavity of the beam trap through at least one light entry opening. The cavity is configured in such a way that a majority of the laser light cannot reemerge from the beam trap through the light entry opening as a result of scattering and/or reflection processes, but rather that said light is absorbed by absorber means (in particular by at least one absorber layer). By way of example, provision can be made for water cooling in order to prevent the beam traps from overheating as a result of laser light being applied onto the absorber means.

Since a majority of the optical radiation energy radiated onto the workpiece during laser machining remains unused, the energy balance of the laser machining apparatuses known from the prior art is relatively inexpedient.

Instead of a laser light source, use can also be made of e.g. (high power) light-emitting diodes, the optical power of which has drastically increased in recent years due to technological developments and which therefore have a promising potential for use as light sources in optical machining apparatuses.

The present invention is based on the object of providing a method for recuperating unused optical radiation energy from an optical machining apparatus, a recuperation apparatus and an optical machining apparatus, which allow the energy balance of the optical machining apparatus to be improved.

In respect of the method, this object is achieved by a method comprising the features of claim 1, in respect of the recuperation apparatus, this object is achieved by a recuperation apparatus comprising the features of claim 4 and by a recuperation apparatus comprising the features of claim 8, and in respect of the optical machining apparatus, this object is achieved by an optical machining apparatus comprising the features of the characterizing part of claim 14. The dependent claims relate to advantageous developments of the invention.

A method according to the invention for recuperating unused optical radiation energy from an optical machining apparatus comprising at least one laser light source comprises the following steps:

operating the at least one light source and generating electromagnetic radiation,

applying the electromagnetic radiation to at least one workpiece for the purposes of machining the workpiece,

capturing at least some of the electromagnetic radiation that was not used for machining the at least one workpiece in a beam trap means of at least one recuperation apparatus,

converting at least some of the optical radiation energy of the electromagnetic radiation captured by the beam trap means of the at least one recuperation apparatus into electrical energy.

The method according to the invention is advantageous in that at least some of the optical radiation energy of the electromagnetic radiation not used for machining the workpiece and captured with the aid of the beam trap means of the at least one recuperation apparatus is converted into electrical current and hence into usable electrical energy. As a result, it is possible for the energy balance of the optical machining apparatus to be improved significantly.

One particularly preferred embodiment proposes that the step of converting at least some of the optical radiation energy into electrical energy comprises the step of applying at least some of the electromagnetic radiation captured by the beam trap means to photovoltaic means. The photovoltaic means are advantageously able to convert at least some of the radiation energy of the captured electromagnetic radiation directly into electrical current, and hence into electrical energy, directly in the interior of the cavity of the beam trap means.

In an alternative embodiment, there is the option that, for the purposes of converting some of the optical radiation energy into electrical energy,

at least some of the electromagnetic radiation captured by the beam trap means is applied to at least one absorber means in the interior of the beam trap means, causing said absorber means to be heated,

a heat transfer fluid is heated by the absorber means,

the heat transfer fluid is conveyed to a heat engine, in particular a steam turbine or a Stirling motor, which is coupled to a generator means such that at least some of the thermal energy of the heat transfer fluid is converted into mechanical energy by means of the heat engine, by means of which mechanical energy the generator means is operated, wherein at least some of the mechanical energy is converted into electrical energy.

In this alternative embodiment it is also possible to use the optical radiation energy of at least some of the electromagnetic radiation which was captured by the beam trap and remained unused for machining the workpiece in order to generate electrical current and hence to provide electrical energy in order thereby to improve the energy balance of the optical machining apparatus. In contrast to the first variant of the invention explained further above, the optical radiation energy is converted in a multi-stage process, in which, initially, at least some of the radiation energy is converted by the absorber means into thermal energy, which can heat the heat transfer fluid. The heat transfer fluid is supplied to the heat engine, in which some of the thermal energy is converted into mechanical energy which can drive the generator means. The generator means in turn is able to generate electrical current and therefore convert at least some of the mechanical energy into electrical energy.

A first variant of a recuperation apparatus according to the invention for recuperating unused electromagnetic radiation energy from an optical machining apparatus comprises

a beam trap means comprising a cavity and at least one light entry opening, through which electromagnetic radiation can enter into the cavity, and

photovoltaic means, which are arranged within the cavity of the beam trap means in such a way that at least some of the electromagnetic radiation that entered into the cavity can be applied thereon and which can convert at least some of the radiation energy from the electromagnetic radiation into electrical energy.

The photovoltaic means are advantageously able, directly in the interior of the cavity of the beam trap means, to convert at least some of the radiation energy of the captured electromagnetic radiation directly into electrical current and hence into electrical energy. As a result, the energy balance of an optical machining apparatus, which includes at least one recuperation apparatus according to the invention, can be improved.

Preferably, the photovoltaic means may comprise a band gap which is selected and set in such a way that it is matched to the wavelength of the electromagnetic radiation. As a result of this measure, the photovoltaic means can be optimized specifically for the intended purpose described here. By way of example, the band gap of the photovoltaic means can be set in such a way that the effectiveness is particularly high in the known, spectrally narrow wavelength of the employed light source. As a result, the two largest loss mechanisms of simple photovoltaic means in sunlight (thermalization at high photon energies and no absorption of photons with an energy that is too low) can effectively be avoided. In order to obtain high efficiency in the case of e.g. a wavelength of the electromagnetic radiation between 900 nm and 1100 nm, the photovoltaic means should include a band gap in the region of approximately 1.12715 eV (energetically, this value corresponds to the wavelength 1100 nm). By way of example, this can be achieved by photovoltaic means comprising thin chalcopyrite layers on the basis of the I-III-VI Cu(In,Ga)Se₂ semiconductor (abbreviated CIGS). By adapting the gallium portion, the band gap can be set between 1.05 eV (CuInSe₂; hence complete substitution of gallium by indium) and 1.68 eV (CuGaSe₂). Photovoltaic means on the basis of GaInAs, as are used e.g. in lower cells in photovoltaic tandem cells, enable absorption of electromagnetic radiation in the range from approximately 740 nm to approximately 1050 nm.

A particularly preferred embodiment proposes that the photovoltaic means are embodied as photovoltaic concentrator means. Photovoltaic concentrator means, as are used in photovoltaic concentrator cells, are distinguished, in particular, in that these are designed for high optical power densities. Such concentrator means are advantageous in that they are able to process high light intensities and can achieve high degrees of efficiency and therefore are able to convert the radiation energy of the electromagnetic radiation into electrical energy in a particularly efficient manner. In order to avoid overheating, there is the option of the photovoltaic concentrator means being cooled by a fluid (e.g. water-cooled) in an advantageous embodiment.

In accordance with claim 8, an alternative recuperation apparatus according to the invention for recuperating unused electromagnetic radiation energy from an optical machining apparatus comprises

a beam trap means comprising a cavity and at least one light entry opening, through which electromagnetic radiation can enter into the cavity,

at least one absorber means, which is arranged within the cavity of the beam trap means and embodied in such a way that it is able to absorb at least some of the electromagnetic radiation entering into the cavity and convert said electromagnetic radiation into thermal energy and heat a heat transfer fluid,

a heat engine to which the heat transfer fluid can be supplied and which is embodied in such a way that it can convert at least some of the thermal energy of the heat transfer fluid into mechanical energy, and

a generator means, which is coupled to the heat engine and embodied in such a way that it can convert at least some of the mechanical energy into electrical energy.

In contrast to the first variant of the invention explained further above, the optical radiation energy is converted in a multistage process in this embodiment of the recuperation apparatus, in which process at least some of the radiation energy is initially converted by the absorber means into thermal energy that can heat the heat transfer fluid. The heat transfer fluid is supplied to the heat engine in which some of the thermal energy is converted into mechanical energy which can drive the generator means. The generator means in turn is able to generate electrical current and therefore able to convert at least some of the mechanical energy into electrical energy.

In order to obtain a design of the recuperation apparatus that is as simple as possible, provision can be made in an advantageous embodiment for the heat engine to be integrated into the beam trap means.

One particularly advantageous embodiment proposes that the heat engine is a steam turbine or a Stirling motor. A Stirling motor is distinguished by its high degree of thermodynamic efficiency.

In order to obtain an even simpler design of the recuperation apparatus, provision can be made in a particularly advantageous embodiment for the generator means to be integrated into the beam trap means.

It is possible that the optical power density of the electromagnetic radiation captured in the beam trap is so high that the photovoltaic means or the absorber means may be damaged. Therefore, one advantageous embodiment proposes that the beam trap means comprises at least one means for attenuating the optical power density of the electromagnetic radiation. The at least one means for attenuating the optical power density can, in particular, be embodied as a reflective or transmissive diffusor means. Alternatively or additionally, the at least one means for attenuating the optical power density can comprise at least one lens means. By way of example, the lens means can be a concave lens means or a convex lens means.

It is possible that the electromagnetic radiation that is returned from, or transmitted by, the workpiece to be machined is very spacious such that the photovoltaic means would have to assume a large area in order to be able to effectively capture the electromagnetic radiation. Therefore, a particularly advantageous embodiment proposes that the beam trap means comprises at least one means for concentrating the optical power density of the electromagnetic radiation.

In accordance with claim 14, an optical machining apparatus for machining a workpiece comprises

at least one light source, in particular a laser light source or a light source comprising a number of light-emitting diodes, which is able to emit electromagnetic radiation during operation,

optical means, which are embodied in such a way that they are able to direct the electromagnetic radiation emitted by the light source onto the workpiece to be machined. The optical machining apparatus according to the invention is distinguished in that it comprises at least one recuperation apparatus as claimed in one of claims 4 to 13. The optical machining apparatus according to the invention therefore has an improved energy balance compared to the optical machining apparatuses, in particular laser machining apparatuses, known from the prior art since at least some of the optical energy that was not used for machining the workpiece can be converted into electrical energy.

In a preferred embodiment, which can further improve the energy balance, the optical machining apparatus can comprise

a first recuperation apparatus, which is arranged in the optical beam path of the optical machining apparatus in such a way that it can capture portions of the electromagnetic radiation that were not used for machining the workpiece and that were reflected by the workpiece, and convert said portions into electrical energy, and

at least a second recuperation apparatus, which is arranged in the optical beam path of the optical machining apparatus in such a way that it can capture transmitted portions of the laser light that was not used for machining the workpiece and convert said portions into electrical energy.

As a result, the option of at least partly recuperating the optical radiation energy of the reflected and transmitted portions of the electromagnetic radiation that were not used for machining the workpiece is provided.

Further features and advantages of the present invention will become clearer on the basis of the following description of preferred exemplary embodiments, with reference being made to the attached figures. In these:

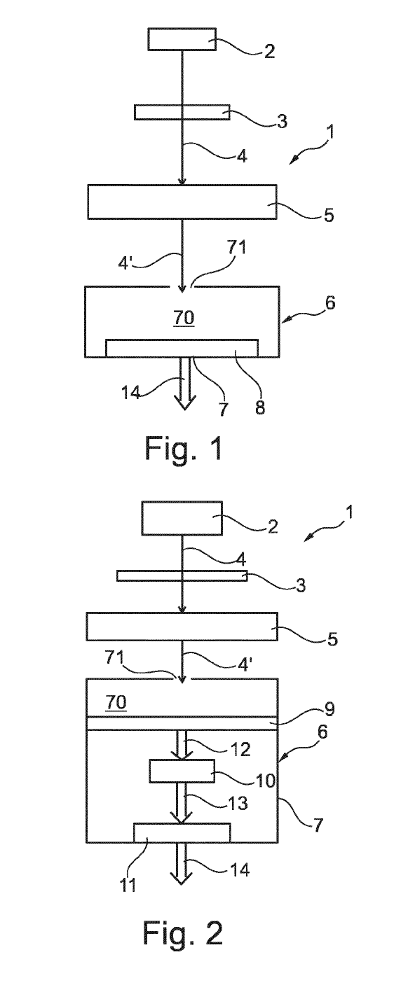

FIG. 1 shows a schematic of a much simplified illustration exemplifying the basic principle of recuperating unused optical radiation energy from an optical machining apparatus by means of at least one recuperation apparatus which is embodied in accordance with a first exemplary embodiment of the present invention,

FIG. 2 shows a schematic of a much simplified illustration exemplifying the basic principle of recuperating unused optical radiation energy from an optical machining apparatus by means of at least one recuperation apparatus which is embodied in accordance with a second exemplary embodiment of the present invention,

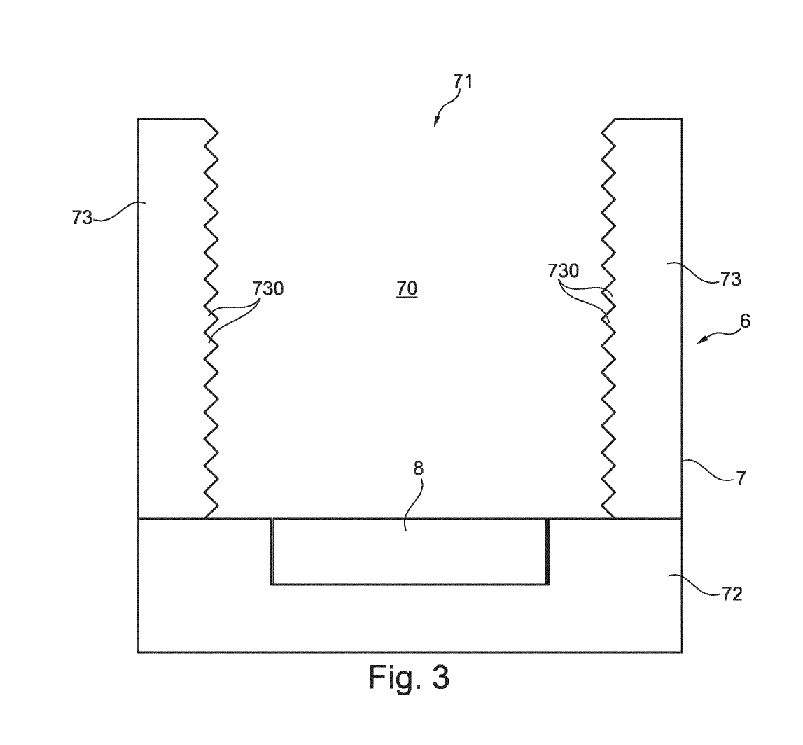

FIG. 3 shows a sectional view of the recuperation apparatus in accordance with FIG. 1,

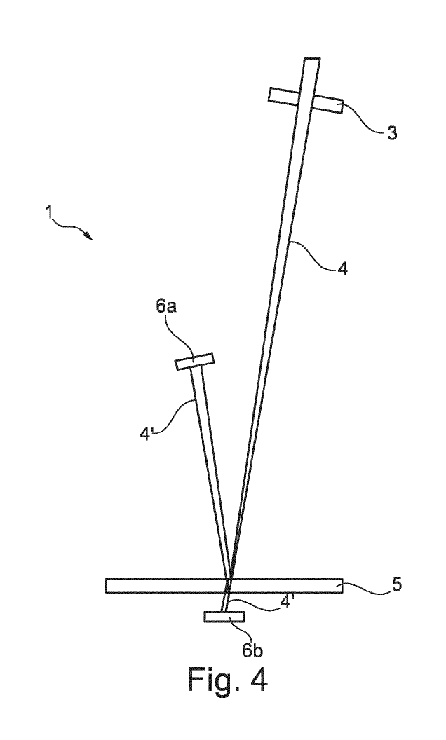

FIG. 4 shows a schematically simplified illustration of an optical machining apparatus comprising two recuperation apparatuses, and

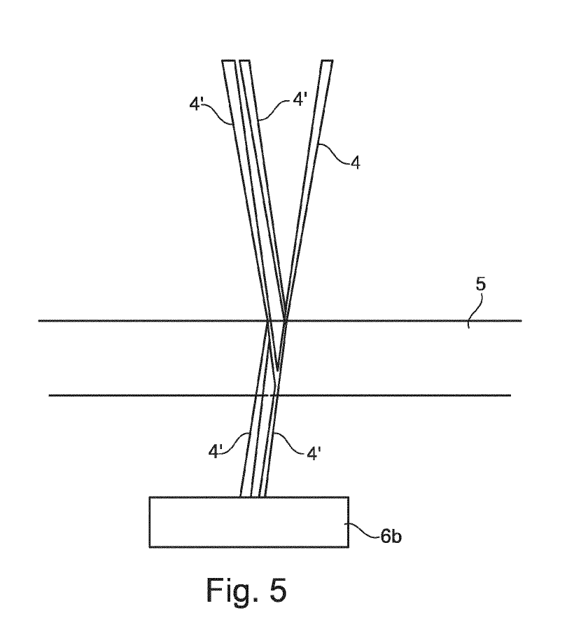

FIG. 5 shows a detail of the beam path of the electromagnetic radiation in the laser machining apparatus in the region of the workpiece.

With reference to FIGS. 1 and 3, a first exemplary embodiment of a method for recuperating unused electromagnetic radiation energy from an optical machining apparatus 1, which is a laser machining apparatus in the present case, for machining a workpiece 5 and the typical design of an optical machining apparatus 1 comprising a recuperation apparatus 6 is to be explained in more detail below. The optical machining apparatus 1 comprises a laser light source 2, which is preferably a diode laser with a multiplicity of individual emitters which are able to emit electromagnetic radiation (laser light) 4 during operation. Alternatively, a CO₂-laser can also be used as laser light source 2. Instead of a laser light source, use can also be made of e.g. (high power) light-emitting diodes, the optical power of which has drastically increased in recent years due to technological developments and which therefore have a promising potential for use as light sources in optical machining apparatuses 1.

The optical machining apparatus 1 furthermore comprises optical means 3, which are embodied in such a way that they can direct the electromagnetic radiation 4 (laser light) emitted by the individual emitters of the laser light source 2 onto the workpiece 5 to be machined by means of the optical machining apparatus 1. The laser light source 2 and the optical means 3 can advantageously be embodied in such a way that a substantially line-shaped intensity distribution of the electromagnetic radiation 4 can be generated on the workpiece 5.

Only a certain portion of the electromagnetic radiation 4 incident on the workpiece 5 is used for the actual machining of the workpiece 5. Usually, this is only a comparatively small part of the optical radiation energy provided by the laser light source 2. By way of example, metallic substances, of which the workpiece 5 may consist, reflect a majority of the laser light 4 radiated thereon. Glasses and the materials used for the production of solar cells, of which the workpiece 5 may consist, transmit and reflect a majority of the electromagnetic radiation 4 radiated thereon. Often, only between approximately 10% and 20% of the irradiated electromagnetic radiation 4 is in fact used for the laser machining process. In some machining methods, even more than 90% of the electromagnetic radiation remains unused in the optical machining process. In order likewise to be able to use the optical radiation energy of the electromagnetic radiation 4′ that was not used for machining the workpiece 5, the optical machining apparatus 1 comprises at least one recuperation apparatus 6, which is intended to be explained in more detail below.

The recuperation apparatus 6, which is merely depicted schematically in a much simplified manner in FIG. 1, comprises a beam trap means 7, which is shown in detail in FIG. 3. The beam trap means 7 includes a cavity 70 delimited by a main body 72 and a number of side walls 73, and at least one light entry opening 71, through which at least some of the electromagnetic radiation 4′ that was not used for machining the workpiece 5 can enter into the cavity 70. In this exemplary embodiment, photovoltaic means 8 are arranged in the main body 72 within the cavity 70 in such a way that at least some of the electromagnetic radiation 4′ that entered into the cavity 70 can be applied thereon and these photovoltaic means are able to directly convert at least some of the optical radiation energy of the electromagnetic radiation 4′ into electrical current and hence into electrical energy 14. The electromagnetic radiation 4′ is preferably incident on the light entry opening 71 in a slightly oblique manner (i.e., expressed differently, not orthogonally to the plane of the light entry opening) in order thereby to avoid that components of the electromagnetic radiation 4′ which may be reflected back out of the cavity 70 are again incident on the laser light source 2 and able to damage the latter under certain circumstances. By way of example, aluminum, aluminum alloys or copper are typical materials from which the main body 72 and the side walls 73 can be produced. One or more cooling channels, through which a coolant, in particular water, may flow during operation of the optical machining apparatus 1 equipped with the recuperation apparatus 6, can be integrated into the main body 72 and into the side walls 73. From FIG. 3, it is possible to identify that the side walls include a structuring 730 which, in this exemplary embodiment, has a zig-zagged design. The relatively small portion of the electromagnetic radiation 4′ entering into the beam trap means 7 that is not converted into either current or heat is incident on the side walls 73 that are provided with the structuring 730 and are preferably colored black. As a result of this, it is possible (at least largely) to prevent that this portion of the electromagnetic radiation 4′ is able to exit the light entry opening 71 of the beam trap means 7 again.

The photovoltaic means 8, which are arranged within the cavity 70 of the beam trap 7, can, for example, be embodied as photovoltaic concentrator means, as are used in photovoltaic concentrator cells. Photovoltaic concentrator means are distinguished, in particular, by virtue of concentrating incident electromagnetic radiation 4′ strongly onto a relatively small light-sensitive region. Such photovoltaic concentrator means are advantageous in that they are able to achieve high degrees of effectiveness, are designed for high optical power densities and are therefore able, particularly efficiently, to convert the optical radiation energy of the electromagnetic radiation 4′ into electrical current and therefore into usable electrical energy. In order to prevent overheating, the photovoltaic means 8 can preferably be fluid cooled.

The photovoltaic means 8 can be optimized specifically for the intended purpose described here. By way of example, the band gap of the photovoltaic means 8 can be set in such a way that the degree of efficiency is particularly high at the known, spectrally narrow wavelength of the employed laser light source 2. As a result, the two largest loss mechanisms of simple photovoltaic means in sunlight (thermalization at high photon energies and no absorption of photons with an energy that is too low) can effectively be avoided.

Referring to FIG. 2, a recuperation apparatus 6 for recuperating unused electromagnetic radiation energy from an optical machining apparatus 1 in accordance with a second exemplary embodiment of the present invention once again comprises a beam trap means 7 comprising a cavity 70 and at least one light entry opening 71, through which at least some of the electromagnetic radiation 4′ that was not used for machining the workpiece can enter into the cavity 70. Once again, the electromagnetic radiation 4′ is preferably incident in a slightly oblique manner on the light entry opening 71 (i.e., expressed differently, not orthogonally to the plane of the light entry opening 71) in order thereby to avoid that components of the electromagnetic radiation 4′ which may be reflected back out of the cavity 70 are incident on the laser light source 2 and able to damage the latter under certain circumstances. The cavity 70 of the beam trap means 7 is preferably—like in the first exemplary embodiment of the recuperation apparatus 6—defined by a main body 72 and a number of side walls 73, which in turn may include structuring 730.

Arranged within the cavity 70 is at least one absorber means 9, which is embodied in such a way that it is able to absorb at least some of the electromagnetic radiation 4′ entering into the cavity 70 and convert at least some of the optical radiation energy of said electromagnetic radiation into thermal energy and heat a heat transfer fluid 12 thereby. The recuperation apparatus 6 furthermore comprises a heat engine 10, to which the heat transfer fluid 12 heated by the at least one absorber means 9 is supplied.

The heat engine 10 is embodied in such a way that it is able to convert at least some of the thermal energy of the heat transfer fluid 12 into mechanical energy 13. By way of example, the heat engine 10 can be a steam turbine or a Stirling motor. Stirling motors in particular are typically distinguished by high degrees of efficiency. The heat engine 10 can—as indicated in FIG. 2—be integrated into the beam trap means 7. Alternatively, the heat engine 10 can also be arranged outside of the beam trap means 7.

Moreover, the recuperation apparatus 6 comprises a generator means 11, which is coupled to the heat engine 10 and embodied in such a way that it is able to convert at least some of the mechanical energy 13 into electrical current and therefore into usable electrical energy 14. The generator means 11 can as indicated in FIG. 2—likewise be integrated into the beam trap means 7. Alternatively, the generator means 11 can also be arranged outside of the beam trap means 7.

A problem possibly arising during the operation of the optical machining apparatus 1 may be that the optical power density of the electromagnetic radiation 4′ captured in the beam trap 7 of the recuperation apparatus 6 is so high that the photovoltaic means 8 or the at least one absorber means 9 may be damaged. In order to remedy these problems, it is possible for the beam trap means 7 to comprise at least one means (not explicitly depicted here) for attenuating the optical power density of the electromagnetic radiation 4′. In particular, the at least one means for attenuating the optical power density may be embodied as a reflective or transmissive diffusor means. Alternatively or additionally, the at least one means for attenuating the optical power density may comprise at least one lens means. By way of example, this lens means may be a concave lens means or a convex lens means.

FIGS. 4 and 5 schematically depict in a much simplified manner the optical beam path of an optical machining apparatus 1 (laser machining apparatus) for machining a workpiece 5. The workpiece 5 is at least partly embodied in a transparent manner and consists of glass or materials used for producing solar cells. The workpiece 5 transmits and reflects a majority of the electromagnetic radiation 4 radiated thereon. In order to be able to use and at least partly recuperate the transmitted and reflected electromagnetic radiation 4′ that was not used for machining the workpiece 5, the optical machining apparatus 1 includes a first recuperation apparatus 6a for the reflected portion and a second recuperation apparatus 6b for the transmitted portion of the unused electromagnetic radiation 4′. The two recuperation apparatuses 6a, 6b are embodied as described above and are able to convert at least part of the optical radiation energy of the unused electromagnetic radiation 4′ into electrical current and therefore into usable electrical energy 14.

The method, described here, for recuperating unused optical radiation energy from an optical machining apparatus 1 (in particular a laser machining apparatus) and the recuperation apparatus 6 are suitable, for example, for laser machining apparatuses, in which use is made of laser light sources 2 with an optical radiation power that is significantly higher than 10 kW. In this context, laser machining apparatuses for thermal machining of metals, for adapting material properties in functional layers or for complementing conventional ovens in the production of solar cells are to be mentioned in an exemplary manner.

The energy balance of such optical machining apparatuses 1 can be substantially improved thereby.

1-15. (canceled)

16. A method for recuperating unused optical radiation energy from an optical machining apparatus having at least one light source, which comprises the following steps of:
operating the at least one light source resulting in a generation of electromagnetic radiation;
applying the electromagnetic radiation to at least one workpiece for machining the workpiece;
capturing at least some of the electromagnetic radiation that was not used for machining the at least one workpiece in a beam trap of at least one recuperation apparatus; and
converting at least some optical radiation energy of the electromagnetic radiation captured by the beam trap of the at least one recuperation apparatus into electrical energy.

17. The method according to claim 16, wherein the step of converting at least some of the optical radiation energy into the electrical energy further comprises the step of applying at least some of the electromagnetic radiation captured by the beam trap to a photovoltaic device.

18. The method according to claim 16, wherein the step of converting some of the optical radiation energy into the electrical energy further comprises the steps of:
applying at least some of the electromagnetic radiation captured by the beam trap to at least one absorber in an interior of the beam trap, causing the absorber to be heated;
heating a heat transfer fluid via the absorber; and
conveying the heat transfer fluid to a heat engine coupled to a generator such that at least some thermal energy of the heat transfer fluid is converted into mechanical energy by the heat engine, by means of which mechanical energy the generator is operated, wherein at least some of the mechanical energy is converted into the electrical energy.

19. The method according to claim 16, which further comprises selecting the at least one light source from the group consisting of laser light sources and light sources having a number of light-emitting diodes.

20. The method according to claim 16, which further comprises selecting the heat engine from the group consisting of a steam turbine and a Stirling motor.

21. A recuperation apparatus for recuperating unused optical radiation energy from an optical machining apparatus, the recuperation apparatus comprising:
a beam trap having a cavity and at least one light entry opening formed therein and through said light entry opening electromagnetic radiation can enter into said cavity; and
a photovoltaic device disposed within said cavity of said beam trap in such a way that at least some of the electromagnetic radiation that entered into said cavity can be applied thereon and said photovoltaic device can convert at least some of the optical radiation energy from the electromagnetic radiation into electrical energy.

22. The recuperation apparatus according to claim 21, wherein said photovoltaic device has a band gap which is selected and set in such a way that the band gap is matched to a wavelength of the electromagnetic radiation.

23. The recuperation apparatus according to claim 21, wherein said photovoltaic device is a photovoltaic concentrator.

24. The recuperation apparatus according to claim 23, wherein said photovoltaic concentrator is cooled by a fluid.

25. A recuperation apparatus for recuperating unused optical radiation energy from an optical machining apparatus, the recuperation apparatus comprising:
a beam trap having a cavity and at least one light entry opening formed therein through which electromagnetic radiation can enter into said cavity;
an absorber disposed within said cavity of said beam trap and embodied such that said absorber being able to absorb at least some of the electromagnetic radiation entering into said cavity and convert said electromagnetic radiation into thermal energy and heat a heat transfer fluid;
a heat engine to which the heat transfer fluid can be supplied, said heat engine converting at least some of the thermal energy of the heat transfer fluid into mechanical energy; and
a generator coupled to said heat engine and converting at least some of the mechanical energy into electrical energy.

26. . The recuperation apparatus according to claim 25, wherein said heat engine is integrated into said beam trap.

27. . The recuperation apparatus according to claim 25, wherein said generator is integrated into said beam trap.

28. The recuperation apparatus according to claim 25, wherein said beam trap has at least one reflective or transmissive diffusor for attenuating an optical power density of the electromagnetic radiation.

29. The recuperation apparatus according to claim 28, wherein said reflective or transmissive diffusor for attenuating the optical power density has at least one lens.

30. The recuperation apparatus according to claim 25, wherein said beam trap contains at least one device for concentrating an optical power density of the electromagnetic radiation.

31. The recuperation apparatus according to claim 25, wherein said heat engine is selected from the group consisting of a steam turbine and a Stirling motor.

32. An optical machining apparatus for machining a workpiece, comprising:
at least one light source emitting electromagnetic radiation during operation;
an optical device for directing the electromagnetic radiation emitted by said light source onto the workpiece to be machined; and
at least one recuperation apparatus according to claim 19.

33. The optical machining apparatus according to claim 32, wherein said at least one recuperation apparatus includes:
a first recuperation apparatus disposed an optical beam path of the optical machining apparatus such that said first recuperation apparatus captures portions of the electromagnetic radiation that were not used for machining the workpiece and that were reflected by the workpiece, and converts the portions into electrical energy; and
at least a second recuperation apparatus disposed in the optical beam path of the optical machining apparatus such that said second recuperation apparatus captures transmitted portions of the electromagnetic radiation that were not used for machining the workpiece and converts the portions into electrical energy.

34. . The optical machining apparatus according to claim 32, wherein said at least one light source is selected from the group consisting of a laser light source and a light source having a number of light-emitting diodes.
